(19) United States
(12) Patent Application Publication
(10) Pub. No.: US 2020/0154977 A1
(43) Pub. Date: May 21, 2020

(54) EXTRACTION AND INSERTION IMPLEMENT AND METHOD OF EXTRACTING FOREIGN OBJECT DEBRIS WITHIN CONFINED SPACES

(71) Applicant: Preston Everson, Layton, UT (US)

(72) Inventor: Preston Everson, Layton, UT (US)

(21) Appl. No.: 15/940,534

(22) Filed: Mar. 29, 2018

(51) Int. Cl. A47L 25/00; B25B 13/48

(52) U.S. Cl. CPC A47L 25/005; B60S 3/008; B25B 13/481

(57) ABSTRACT

An extraction and insertion implement and method of retrieving foreign object debris and inserting fasteners in small spaces providing a rigid rod that is held and manipulated between fingers. A resilient bulbous member joins a distal end of the rod. The bulbous member is resilient to compression for positioning within confined spaces and has a bulbous shape to optimize engagement with FOD and fasteners. An adhesive member detachably encapsulates the bulbous member. The bulbous member can be precisely manipulated from the rod to extract and insert FOD and fasteners in small spaces. The adhesive member comprises an adhesive that binds with FOD and fasteners to extract and insert into the small space. The adhesive member may be removed from the bulbous member so that after use, the contaminated adhesive member can be removed and replaced with a new adhesive member. The implement may be used in medical application and various embodiments may detachable affix to a driver.

### FIELD OF THE INVENTION

This invention relates to an extraction and insertion implement and method of extracting and inserting foreign object debris and fasteners within confined spaces, and more particularly relates to a implement having a rod that is configured to be held and manipulated between the fingers, and a resilient bulbous member joined at a distal end of the rod that is detachably encapsulated by at least one replaceable adhesive member, such that the resilient bulbous member can be precisely manipulated for extracting foreign object debris and inserting fasteners in small spaces, and the adhesive member binds with foreign object debris and a fastener to extract or insert the foreign object debris and the fastener into a small space.

### BACKGROUND

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Aircraft mechanics must exercise extreme caution when repairing aircraft that foreign object debris (FOD) is not left behind avionics or anywhere within the plane during maintenance operations. Numerous accidents have resulted from FOD as small as a few millimeters from becoming lodged between control surfaces and the airframe, or in such a manner as to inhibit movement of pilot-controlled yolks and sticks, frequently causing not just the loss of aircraft worth tens or hundreds of millions of dollars but also the lives of the pilot and aviation personnel. The same concerns exist in automotive repair operations, as well as repair operations on countless other types of machinery.

Screws and bolts must often be inserted into confined areas during repair operations and twisted into threading before a screwdriver is used to completed threading engagement. Because efficient means of inserting screws and extracting FOD from confined spaces are unknown in the art, military aircraft mechanics resort to using chewing gum to insert and retrieve FOB, which can itself become lost and become FOD.

In many instances, fasteners, such as screws, bolts, and pins are inserted in bore holes. Tools used to extract the fasteners may not be able to fully extract the fasteners, once the leverage from torque is finished—generally after the fastener is partially removed from a threaded or friction fit surface.

Although it is known in the art that cotton swabs, or Q-tips, are useful implements used in various cleaning and personal grooming applications, the same have never been incorporated into larger implements for application in other industries. The cotton swab of Q-tips often includes a small wad of cotton that is wrapped around one or both ends of a short shaft. The shaft is often constructed of wood, rolled paper, or plastic. Typically, residual matter, such as ear wax, mucus, and grime are removed with a small implement, such as a cotton swab.

Efficient means of inserting and/or extracting small apparati and debris from confined spaces are unknown. There exists a need in the art for a method, system and apparatus for curing this deficiency, which deficiency the present teaching remedy as an object of the present invention.

### SUMMARY

From the foregoing discussion, it should be apparent that a need exists for an extraction and insertion implement and method of extracting and inserting foreign object debris and fasteners in small spaces. Beneficially, such an implement and method would include a rod that is held between the fingers for precise manipulation in small spaces; and include a resilient bulbous member attached to a distal end of the rod; and include an adhesive member that detachably encapsulates the bulbous member to bind with the foreign object debris and fastener; whereby the contaminated adhesive member is replaceable with a new adhesive member.

The present invention has been developed in response to the present state of the art, and in particular, in response to the problems and needs in the art that have not yet been fully solved by currently available tools that can both extract and insert foreign object debris and fasteners in small spaces. Accordingly, the present invention has been developed to provide an extraction and insertion implement and method of extracting and inserting foreign object debris and fasteners in small spaces that overcome many or all of the above-discussed shortcomings in the art.

These modules in the described embodiments include a rod that is defined by a proximal end and a distal end. The rod is generally rigid and elongated so that the distal end can reach into, and be manipulated in a small space. A resilient bulbous member joins with the distal end of the rod. The resilient configuration of the bulbous member enables the bulbous member to be compressed for fitting into small spaces. The resilient bulbous member is defined by a large surface area that amplifies engagement with foreign object debris and fasteners.

At least one adhesive member detachably encapsulates the bulbous member. The adhesive member comprises an adhesive that is defined by a bonding affinity that enables binding with the foreign object debris and the fasteners until a force is applied to break the bond. After use, the contaminated adhesive member may be removed from the resilient bulbous member and replaced with a new adhesive member.

In another embodiment, the rod is cylindrical in shape.

In yet another embodiment, the bulbous member is integral with the distal end of the rod.

In yet another embodiment, the bulbous member has a generally bulbous shape.

In yet another embodiment, the adhesive member is defined by a generally flat, flexible panel.

In yet another embodiment, the panel is defined an internal side and an external side.

In yet another embodiment, the internal side of the panel adheres to the bulbous member.

In yet another embodiment, the external side of the panel comprises an adhesive, including a zero residue adhesive.

In yet another embodiment, the adhesive member is integral with the bulbous member.

In yet another embodiment, the adhesive member peels off the bulbous member.

In yet another embodiment, the rod and the bulbous member comprise a Q-tip or a cotton swab.

A method of the present invention is also presented for a method of retrieving foreign object debris and inserting fasteners in small spaces. The method in the disclosed embodiments substantially includes the steps necessary to carry out the functions presented above with respect to the operation of the described apparatus and system. In one embodiment, the method includes an initial Step of providing an implement defined by a rod having a proximal end and a distal end, with the distal end of the rod joining with a resilient bulbous member detachably encapsulated by at least one adhesive member.

The method also may include a Step of grasping the proximal end of the rod between the fingers.

In some embodiments, the method may include a Step of orienting the distal end of the rod towards a small space.

In a further embodiment, the method includes fitting the bulbous member into the small space, whereby the resilient configuration enables a snug fit into the small space.

In a further embodiment, the method includes engaging a foreign object debris with the resilient bulbous member, whereby the large surface area of the resilient bulbous member amplifies engagement with the foreign object debris.

In a further embodiment, the method includes manipulating the rod between the fingers.

In a further embodiment, the method includes extracting the foreign object debris from the small space, whereby the adhesive member binds with the foreign object debris.

In a further embodiment, the method includes removing the contaminated adhesive member from the resilient bulbous member.

In a further embodiment, the method includes detachably encapsulating the resilient bulbous member with a new adhesive member.

In a further embodiment, the method includes engaging a fastener with the resilient bulbous member, whereby the large surface area of the bulbous member amplifies engagement with the fastener.

In a further embodiment, the method includes manipulating the rod between the fingers.

In a further embodiment, the method includes inserting the fastener into the small space, whereby the new adhesive member binds with the fastener.

A final Step comprises applying a force to the implement to break the bond between the new adhesive member and the fastener.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of an extraction and insertion implement for retrieving foreign object debris and inserting fasteners in small spaces, in accordance with the present invention;

FIG. 2 is a perspective view further illustrating the extraction and insertion implement of FIG. 1, showing an adhesive member being peeled off a bulbous member, in accordance with the present invention;

FIG. 3 is a perspective view illustrating an extraction and insertion implement extracting foreign object debris from a slot in a vehicle console, in accordance with the present invention;

FIG. 4 is a perspective view illustrating an extraction and insertion implement extracting foreign object debris from a ridge in a vehicle console, in accordance with the present invention;

FIG. 5 is a perspective view illustrating an extraction and insertion implement extracting foreign object debris from a circular dial in a vehicle console, in accordance with the present invention;

FIG. 6 is a perspective view illustrating an extraction and insertion implement extracting foreign object debris from an engine of an airplane, in accordance with the present invention;

FIG. 7A is a perspective views of an implement inserting a fastener into a screw hole of a vehicle console, in accordance with the present invention;

FIG. 7B is a perspective views of a tool completing the insertion of the fastener shown in FIG. 7A, in accordance with the present invention;

FIG. 8 is a flowchart illustrating one embodiment of a method of extracting and inserting foreign object debris and fasteners in small spaces, in accordance with the present invention;

FIG. 8 is an environmental side perspective view of a detachable extraction implement in accordance with the present invention; and

FIG. 9 is an environmental side perspective view of a package of detachable extraction implements in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

It is to be understood that a “small space 202a-e” described herein may include, without limitation, an ear, a nostril, an eye, a mouth, an anus, the space between the fingers and toes, a car console component, and a screw hole. In a more general sense, the small space 202a-e includes a bore hole, a crevice, a ridge, an opening, a cavity, an irregular hole, and any space having a width of less than 2″. The “foreign object debris” (FOD) may include, without limitation, ear wax, mucus, urine, fecal matter, lint, dust, grit, and grease. The fastener 208 may include, without limitation, a screw, a bolt, a pin, a button, and a nail. However, these are not limiting definitions.

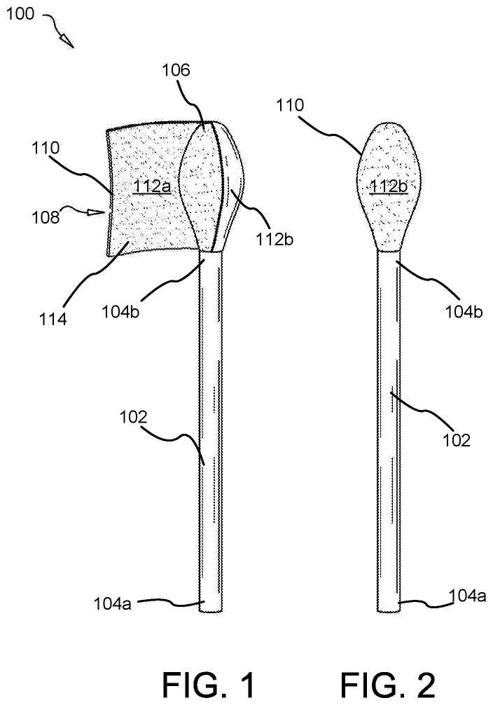

FIG. 1 depicts an extraction and insertion implement 100 for extracting and inserting FOD and fasteners 208 in small spaces 202a-e. The extraction and insertion implement 100, hereafter “implement 100”, comprises a rod 102 that is configured to be held and manipulated between the fingers 204. The rod 102 is defined by a proximal end 104a and a distal end 104b. The proximal end 104a may be held between the fingers 204 for manipulation of the rod 102. The manipulations of the rod 102 is for the purpose of extracting and inserting FOD and fasteners 208 in the small space 202a-e. For example, the proximal end 104a is gripped for dabbing, rolling, and laterally swiping the distal end 104b of the rod 102 in and around the small space 202a-e.

In one non-limiting embodiment, the rod 102 is generally rigid and elongated. The rigid configuration allows the rod 102 to be manipulated in and around small spaces 202a-e, crevices, holes, and irregular cavities without bending or breaking. This rigidity provides greater control and stability of the rod 102 when being manipulated axially and laterally in small spaces 202a-e. The rod 102 may also have a generally cylindrical shape. The cylindrical shape allows the rod 102 to roll along the surface of the finger tips when being gripped. This cylindrical shape creates a smoother rotational motion for rotating the rod 102 in small spaces 202a-e.

However in other embodiments, the rod 102 may be semi-rigid, and may also have multiple distinct faces, rather than a cylindrical shape. The semi-rigid rod is adaptable to bend around corners; while the multi-faceted rod is prevented from rolling off a surface when not in use.

The implement 100 further comprises a resilient bulbous member 106 that joins with the distal end 104b of the rod 102. Through manipulation of the attached rod 102, the resilient bulbous member 106 can be precisely manipulated for entering and egressing small spaces 202a-e to extract FOD, or insert a fastener 208 therein. The bulbous member 106 may rub against, dab, swipe, or roll along the inner surface of the small space 202a-e; or around the exterior area of the small space 202a-e.

In one embodiment, the resilient bulbous member 106 is a bulbous-shaped wad of cotton. In this configuration, the rod 102 and bulbous member 106 may be a Q-tip or a cotton swab, as is known in the art. Though in other embodiments, the resilient bulbous member 106 may include a bulbous-shaped wad fabricated from fibers, paper, rubber, wood pulp, or any generally resilient material. The resilient configuration of the bulbous member 106 enables fitting into small spaces 202a-e. For example, the bulbous member 106 compresses to squeeze into an earhole, a screw borehole, or a vehicle console opening.

The resilient bulbous member 106 is also unique in that it is defined by a large surface area. Those skilled in the art will recognize that a bulbous shape has greater surface area than an elongated oval shape or an orb shape. The large surface provided by the bulbous shape works to amplify engagement with the FOD and fasteners 208 inside the small spaces 202a-e. Thus, by combining both characteristics of resiliency and a large surface area, the bulbous member 106 is compressible to be forced into small spaces 202a-e, while also being sufficiently large to engage a substantial amount of the inner surface of the small space 202a-e.

In one embodiment, the resilient bulbous member 106 is integral with the distal end 104b of the rod 102. In this integral configuration, the bulbous member 106 is fixedly attached to the distal end 104b of the rod 102. In another embodiment, the resilient bulbous member 106 detachably attaches to the distal end 104b of the rod 102. In this embodiment, the rod 102 and the bulbous member 106 may be fastened through welding, adhesion, fasteners 208, or a magnet. In yet another embodiment, two bulbous members join with the distal and proximal end 104a-b of the rod 102. This allows for extracting and inserting FOD and fasteners 208 from both ends 104a-b of the rod 102.

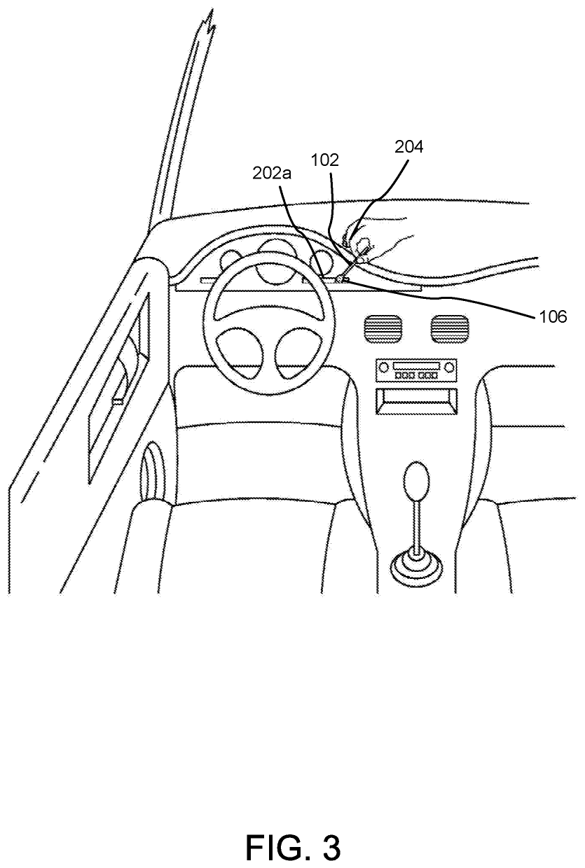

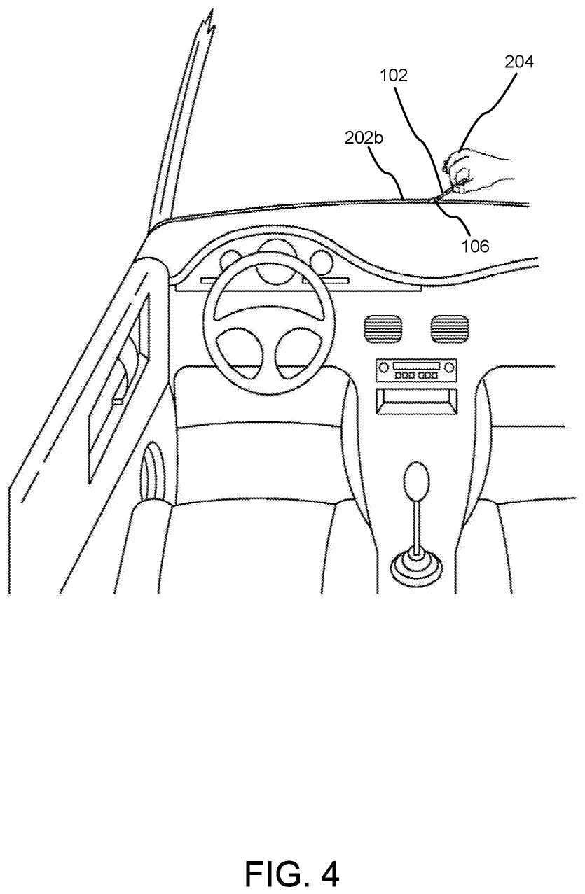

In some embodiments, at least one adhesive member 108 detachably encapsulates the resilient bulbous member 106. The adhesive member 108 is configured to bind with the FOB or fastener 208 inside the small space 202a-e, so as to enable removal, insertion, or manipulation thereof. For example, FIG. 3 shows the implement 100 extracting foreign object debris, such as dust, from a slot 202a in a vehicle console. FIG. 4 shows the implement 100 extracting foreign object debris, such as hair strands, from a ridge 202b in a vehicle console. In each case, the rod 102 is manipulated, the resilient bulbous member 106 fits into the small space, and the adhesive member 108 binds with the FOD.

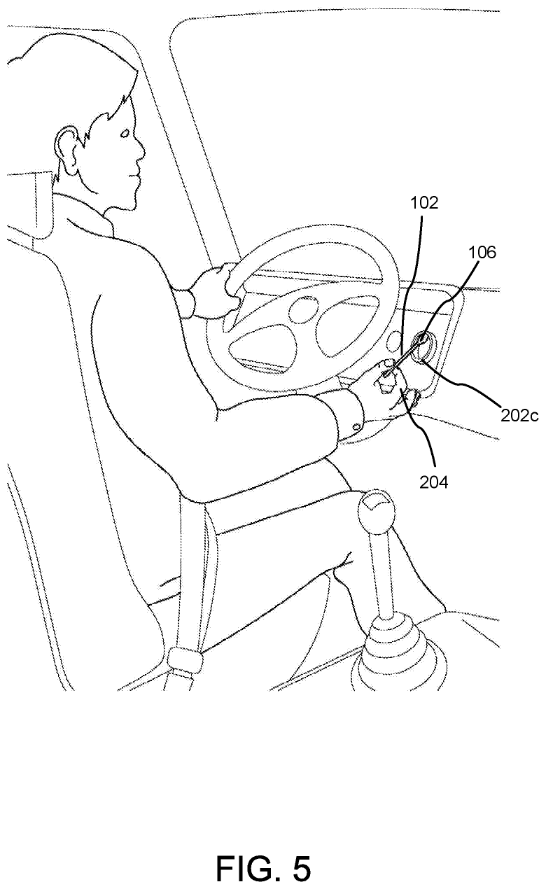

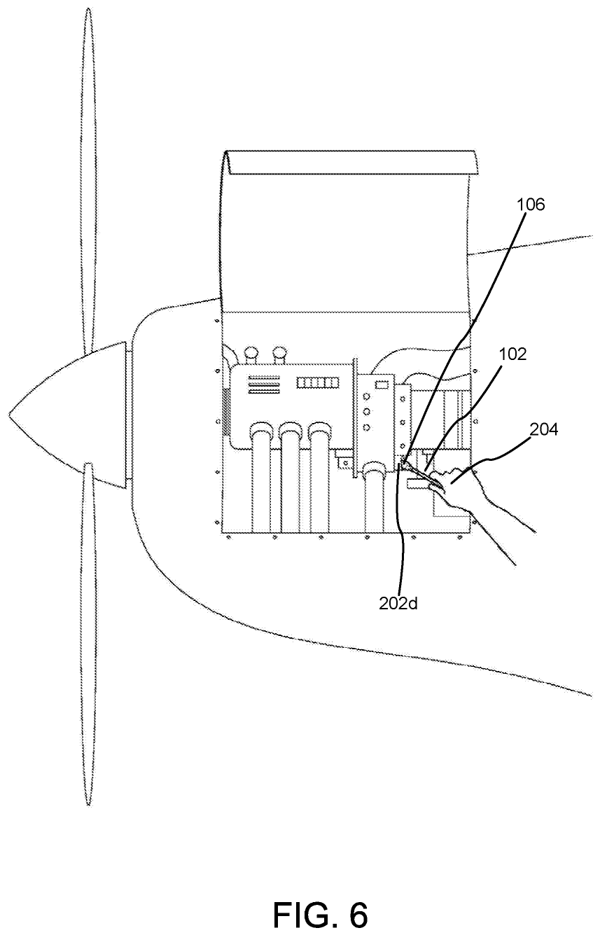

Continuing with other illustrative examples of the extraction of FOD, FIG. 5 shows the implement 100 extracting foreign object debris, such as mucas, from a circular dial 202c in a vehicle console. FIG. 6 shows the implement 100 extracting foreign object debris, such as engine grime and grease, from an engine 202d of an airplane. These and other examples illustrate how the bulbous member 106 is inserted into the small space 202a-e, manipulated through the rod 102, and finally extracted to dispose of the FOD.

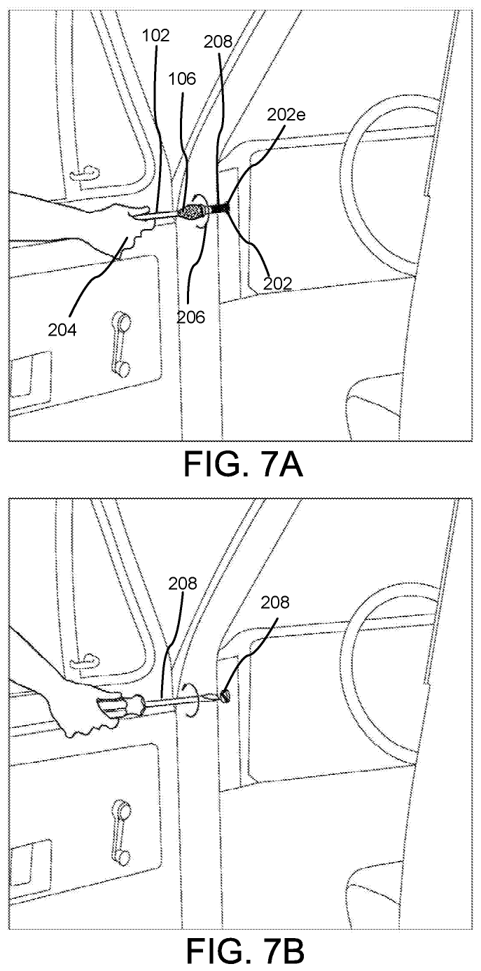

Further, the implement 100 is also used to insert and extract fasteners 208 into the small space 202a-e (FIGS. 7A-7B). The fasteners 208 may include, without limitation, a screw, a bolt, a pin, a button, and a nail. For example, FIG. 7A illustrates the implement 100 inserting a fastener 208 into a small space (screw borehole 202e) in a vehicle console. Here, the adhesive member 108 directly engages the head of the fastener 208 (a screw). The adhesive 114 bond is sufficiently strong enough to enable rotational insertion of the screw at least partially into the screw borehole 202e. When greater torque is need to continue the insertion of the screw, a force 206 is applied to the rod 102 to break the bonding affinity of the adhesive 114. This force can include an upward force, a downward force, or a rotational force.

FIG. 7B shows a tool 210, such as screw driver, completing the insertion of the fastener 208 into the screw hole. This may be necessary when the bonding affinity of the adhesive 114 is insufficient to remove or firmly insert the screw into the screw borehole 202e. In reverse, the tool 210 may begin the extraction of the screw until partially removed. After the larger torque is overcome with the tool 210, the bulbous member 106 is more adapt at removing the screw with the weaker bonding affinity created by the adhesive 114.

In some embodiments, the adhesive member 108 may include a generally flat, flexible panel 110. The panel 110 may have an internal side 112a and an external side 112b. The external side 112b comprises an adhesive 114 that binds with the FOD or fastener 208. The adhesive 114 is defined by a generally bonding affinity that enables the binding with the foreign object debris and the fasteners 208, until a force is applied to break the bond.

In another embodiment, the adhesive 114 comprises a zero residue adhesive 114 that does not leave adhesive 114 matter in the small space 202a-e or fastener 208 contained therein. Those skilled in the art will recognize that it may be advantageous to maintain a clean inner surface of the small space 202a-e when retrieving and inserting FOD and fasteners 208. For example, when detailing the console of a vehicle, as shown in FIGS. 3 and 4, the objective is to remove FOB, and not leave any other residual matter on the console, seats, or other vehicle components.

Thus, the adhesive 114 properties of the bulbous member 106, along with the finger-held manipulation of the rod 102, discussed above, enhances the precise manipulation in the small space 202a-e by allowing the FOD and fastener 208 to be lifted, rotated, and axially moved to and from the small space 202a-e.

In some embodiments, the internal side 112a of the panel 110 may adhere to the surface of the bulbous member 106. This detachable adhesion enables the panel 110 to peel or separate from the bulbous member 106. FIG. 2 illustrates a panel 110 being peeled off the bulbous member 106 in a radial motion. It is significant to note that any non-adhesive 114 portion of the panel 110 may be fabricated from a substantially polyethylene material.

In some embodiments, the panel 110 may include a protruding section that provides a surface for the finger to grab, so as to peel off or wrap the panel 110 to the bulbous member 106. In this manner, a contaminated adhesive member can be removed from the bulbous member 106 and replaced with a new adhesive member. For example, after binding with, and removing mucus from the ear; the mucus laced adhesive member is peeled off the bulbous member 106 and replaced with a new adhesive member. The new adhesive member is then reinserted into the mouth or nose for further extraction of FOD.

In other embodiments, the adhesive member 108 is not removable, but rather integral with the bulbous member 106. In this configuration, the adhesive member 108 does not peel off the bulbous member 106. This integral configuration may be utilized for a disposable implement, or when a detachable bulbous member is used, in which the entire bulbous member 106 and adhesive member 108 assembly is detached from the distal end 104b of the rod 102. FIG. 1 illustrates the integral configuration of the implement 100 in which the adhesive member 108 is integral with the bulbous member 106.

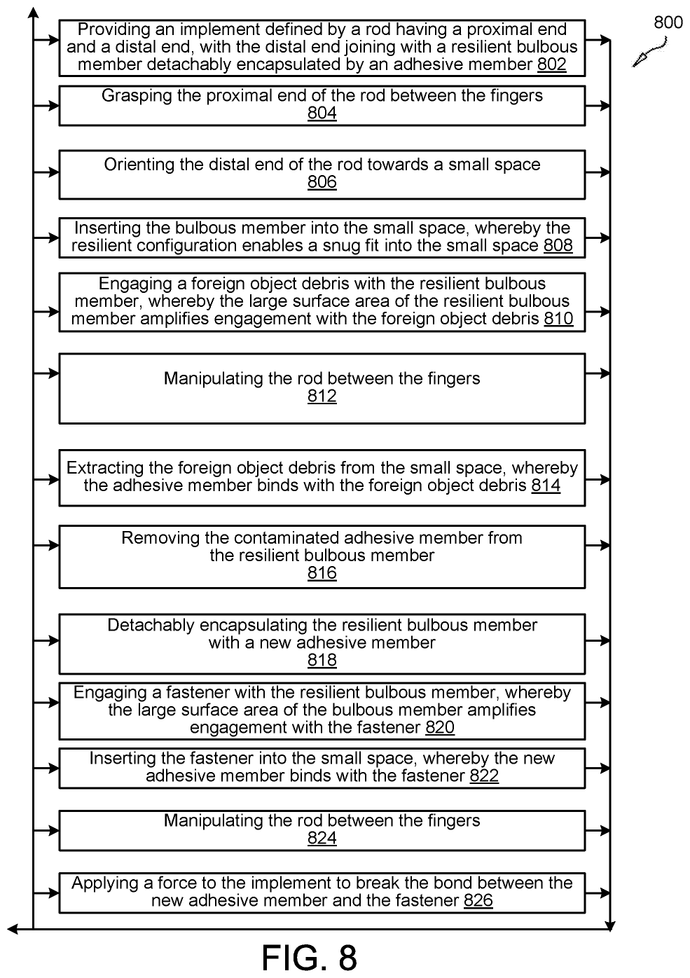

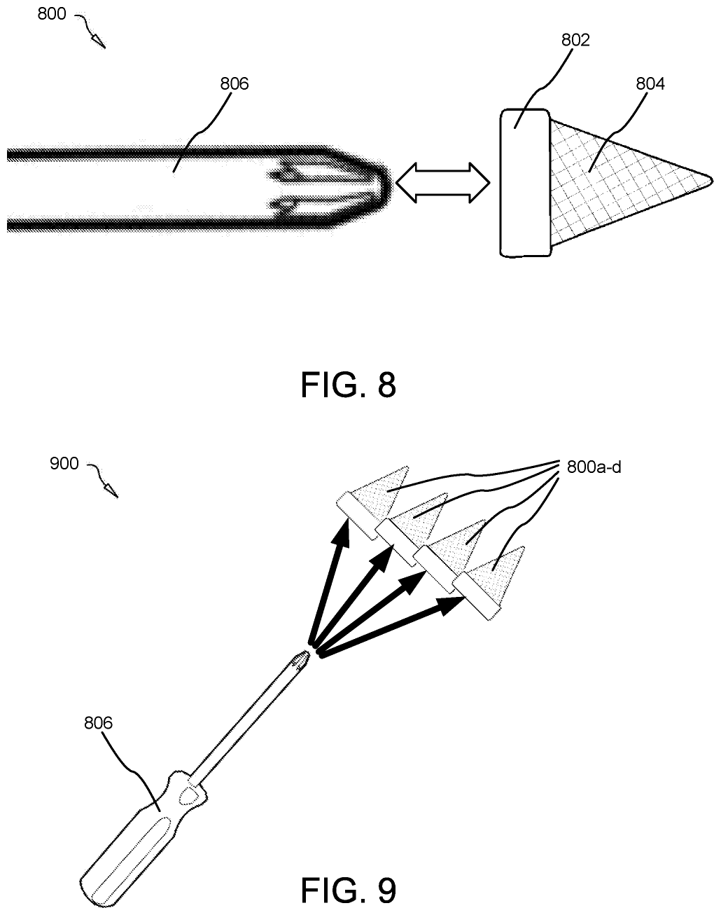

FIG. 8 illustrates a flowchart illustrating one embodiment of a method 800 of extracting and inserting foreign object debris and fasteners 208 in small spaces 202a-e. The method 800 in the disclosed embodiments substantially includes the steps necessary to carry out the functions presented above with respect to the operation of the described implement 100. In one embodiment, the method 800 includes an initial Step 802 of providing an implement 100 defined by a rod 102 having a proximal end 104a and a distal end 104b, with the distal end 104b of the rod 102 joining with a resilient bulbous member 106 detachably encapsulated by at least one adhesive member 108.

The method 800 also may include a Step 804 of grasping the proximal end 104a of the rod 102 between the fingers 204. The elongated, cylindrical shape of the rod 102 allows for easy grasping, rolling, and axial manipulation of the rod 102. The manipulations of the rod 102 are for the purpose of extracting and inserting FOD and fasteners 208 into the small space 202a-e. For example, dabbing, rolling, and laterally swiping the rod 102 in and around the small space 202a-e.

In some embodiments, the method 800 may include a Step 806 of orienting the distal end 104b of the rod 102 towards a small space 202a-e. The distal end 104b of the rod 102 has attached thereto the resilient bulbous member 106, which engages the FOD and fastener 208.

In a further embodiment, the method 800 includes a Step 808 of inserting the bulbous member 106 into the small space 202a-e, whereby the resilient configuration enables a snug fit into the small space 202a-e. The resilient configuration of the bulbous member 106 compresses to fit into the small space 202a-e. The large surface area represented by a bulbous shape maximizes engagement with the inner surface of the small space 202a-e.

In a further embodiment, the method 800 includes a Step 810 of engaging a foreign object debris with the resilient bulbous member 106, whereby the large surface area of the resilient bulbous member 106 amplifies engagement with the foreign object debris. The bulbous member 106 may rub against, dab, or roll in the inner surface of the small space 202a-e, or around the exterior area of the small space 202a-e.

In a further embodiment, the method 800 includes a Step 812 of manipulating the rod 102 between the fingers 204. The rod 102 may be manipulated axially, laterally, or rotationally in and around the small space 202a-e.

In a further embodiment, the method 800 includes a Step 814 of extracting the foreign object debris from the small space 202a-e, whereby the adhesive member 108 binds with the foreign object debris. The adhesive 114 is sufficiently adherent to stick to the FOD, which may itself have a stickiness. The rod 102 is pulled outwardly to remove the bulbous member 106 from the small space 202a-e.

In a further embodiment, the method 800 includes a Step 816 of removing the contaminated adhesive member 108 from the resilient bulbous member 106. In one embodiment, the adhesive member 108 comprises a panel 110. The panel 110 comprises an internal side 112a that adheres to the surface of the bulbous member 106. This allows the panel 110 to be peeled off the bulbous member 106.

In a further embodiment, the method 800 includes a Step 818 of detachably encapsulating the resilient bulbous member 106 with a new adhesive member 108. The new adhesive member 108 is wrapped around the bulbous member 106, substantially covering the surface area thereof.

In a further embodiment, the method 800 includes a Step 820 of engaging a fastener 208 with the resilient bulbous member 106, whereby the large surface area of the bulbous member 106 amplifies engagement with the fastener 208. The adhesive 114 on the adhesive member 108 adheres to the end of the fastener 208, which may include a flat head of a screw, bolt, or nail.

In a further embodiment, the method 800 includes a Step 822 of inserting the fastener 208 into the small space 202a-e, whereby the new adhesive member 108 binds with the fastener 208. The adhesion between the adhesive member 108 and the fastener 208 is sufficient to allow for manipulating the heavier fastener 208.

In a further embodiment, the method 800 includes a Step 824 of manipulating the rod 102 between the fingers 204. The rod 102 may be manipulated axially, laterally, or rotationally in and around the small space 202a-e. However, the fastener 208 may require rotational and axial manipulations by the rod 102, more than the lateral and dabbing manipulations required to remove FOD.

A final Step 826 comprises applying a force 206 to the implement 100 to break the bond between the new adhesive member 108 and the fastener 208. The force 206 may include a sharp downward motion, upward motion, rotational motion, or axial motion that is applied to the proximal end 104a of the rod 102. The force 206 is generally sufficient to overcome the adhesion between the adhesive member 108 and the fastener 208; thereby breaking the bond therebetween.

In various embodiments of the present invention, the rod 102 may be used for medical applications. The rod 102 and other implements, apparti, methods and systems herein described may be used to insert screws during surgery and/or retrieve dropped medical devices, such as screws, sponges, surgical ligation clips, scalpels, and the like.

FIG. 8 is an environmental side perspective view of a detachable extraction implement 800 in accordance with the present invention.

The detachable extraction implement 800 may comprise a conical distal end 804 formed of foam, cotton, or other organic or elastomeric materials (e.g., wood, leather, sponges, and the like).

In various embodiments, the conical distal end 804 is circumscribed by an annular flange or annular ring 802 affixed using means known to those of skill in the art to the open proximal end of the conical distal end 802. The annular flange 802 may be formed of cardboard, polymeric materials, or other materials known to those of skill in the art.

The detachable extraction implement 800 may be adapted to engage the distal end of a screw driver 806, drill bit, shaft, rod, stick, pipe, tube or other elongated handheld driving implement known to those of skill in the art.

In various embodiments, the outer surface of the conical distal end 804 is layered with zero res adhesive and/or adhesive known to those of skill in the art. The inner surface of the conical distal end 804 may also be layered with adhesive to bind with the driver 806. The inner surface of the conical distal and/or the annular ring 802 end 804 may be adapted to form a friction fit with the driver 806.

FIG. 9 is an environmental side perspective view of a package 900 of detachable extraction implements in accordance with the present invention.

The detachable implements may come in a plurality in packaged form.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An implement to extract and insert foreign object debris and fasteners in small spaces, the implement comprising:
a rod being defined by a proximal end and a distal end, the rod further being generally rigid and elongated;
a resilient bulbous member joined with the distal end of the rod, the resilient bulbous member being substantially resilient, the resilient bulbous member being defined by a generally bulbous shape; and
at least one adhesive member detachably encapsulating the resilient bulbous member, whereby the adhesive member is replaceable, the adhesive member being defined by an internal side and an external side, the internal side engaging the resilient bulbous member, the external side comprising an adhesive.

2. The implement of claim 1, wherein the rod has a generally cylindrical shape.

3. The implement of claim 1, wherein the bulbous member has a generally bulbous shape.

4. The implement of claim 1, wherein the bulbous member is integral with the distal end of the rod.

5. The implement of claim 1, wherein the bulbous member is detachable from the distal end of the rod.

6. The implement of claim 1, wherein the bulbous member comprises cotton.

7. The implement of claim 1, wherein the rod and the bulbous member comprise a Q-tip or a cotton swab.

8. The implement of claim 1, wherein the adhesive member is defined by a generally flat, flexible panel.

9. The implement of claim 1, wherein the internal side of the adhesive member adheres to the bulbous member.

10. The implement of claim 9, wherein the adhesive member peels off the bulbous member.

11. The implement of claim 1, wherein the adhesive member is integral with the bulbous member.

12. The implement of claim 1, wherein the adhesive on the external side of the adhesive member comprises a zero residue adhesive.

13. An implement to extract and insert foreign object debris and fasteners in small spaces, the implement consisting of:
a rod being defined by a proximal end and a distal end, the rod further being generally rigid and elongated, the rod further having a generally cylindrical shape;
a resilient bulbous member joined with the distal end of the rod, the resilient bulbous member being substantially resilient, the resilient bulbous member being defined by a generally bulbous shape; and
at least one adhesive member detachably encapsulating the resilient bulbous member, whereby the adhesive member is replaceable, the adhesive member being defined by a flat panel, the panel having an internal side and an external side, the internal side adhering to the resilient bulbous member, the external side comprising a zero residue adhesive.

14. The implement of claim 13, wherein the bulbous member is integral with the distal end of the rod.

15. The implement of claim 13, wherein the bulbous member is detachable from the distal end of the rod.

16. The implement of claim 13, wherein the bulbous member comprises cotton.

17. The implement of claim 13, wherein the rod and the bulbous member comprise a Q-tip or a cotton swab.

18. The implement of claim 13, wherein the adhesive member peels off the bulbous member.

19. The implement of claim 13, wherein the implement is adapted for use in surgical applications.

20. A method of extracting and inserting foreign object debris and fasteners in small spaces, the method comprising:
providing an implement defined by a rod having a proximal end and a distal end, with the distal end of the rod joining with a resilient bulbous member detachably encapsulated by at least one adhesive member;
grasping the proximal end of the rod between the fingers;
orienting the distal end of the rod towards a small space;
inserting the bulbous member into the small space, whereby the resilient configuration enables a snug fit into the small space;
engaging a foreign object debris with the resilient bulbous member, whereby the large surface area of the resilient bulbous member amplifies engagement with the foreign object debris;
manipulating the rod between the fingers;
extracting the foreign object debris from the small space, whereby the adhesive member binds with the foreign object debris;
removing the contaminated adhesive member from the resilient bulbous member;
detachably encapsulating the resilient bulbous member with a new adhesive member;
engaging a fastener with the resilient bulbous member, whereby the large surface area of the bulbous member amplifies engagement with the fastener;
inserting the fastener into the small space, whereby the new adhesive member binds with the fastener;
manipulating the rod between the fingers; and
applying a force to the implement to break the bond between the new adhesive member and the fastener.
